(19) United States
(12) Patent Application Publication
(10) Pub. No.: US 2025/0059303 A1
(43) Pub. Date: Feb. 20, 2025

(54) Method of Suppressing Plugging in Manufacturing Process of Ethylene-Acrylic Acid Copolymer

(71) Applicants: SK Innovation Co. Ltd., Seoul (KR); SK Geo Centric Co., Ltd., Seoul (KR)

(72) Inventors: Ho Seong Lee, Daejeon (KR); Ji Hye Park, Daejeon (KR); Won Bin Kim, Daejeon (KR); Hong Chan Kim, Daejeon (KR); In Su Lee, Daejeon (KR); Wan Ju Jeong, Daejeon (KR); Seok Bin Hong, Daejeon (KR)

(21) Appl. No.: 18/804,523

(22) Filed: Aug. 14, 2024

(30) Foreign Application Priority Data
Aug. 16, 2023 (KR) 10-2023-0106743

(51) Int. Cl. C08F 2/00; C08F 2/01; C08F 210/02; C08F 220/06

(52) U.S. Cl. CPC C08F 2/007; C08F 2/01; C08F 210/02; C08F 220/06; C08F 2400/02

(57) ABSTRACT

Provided is a method of manufacturing an ethylene-acrylic acid copolymer including the step of (S1) supplying an ethylene monomer and an acrylic acid comonomer to a polymerization reactor to manufacture an ethylene-acrylic acid copolymer; (S2) supplying an acrylic acid comonomer-containing mixture discharged from a front or rear end of the polymerization reactor and a cleaning solvent to a cleaning unit; and (S3) dissolving an polyacrylic acid derived from the acrylic acid comonomer contained in the mixture in the cleaning solvent. The cleaning solvent includes a polyhydric alcohol-based solvent.

### CROSS-REFERENCE TO RELATED APPLICATION

This application claims priority to Korean Patent Application No. 10-2023-0106743, filed Aug. 16, 2023, the disclosure of which is hereby incorporated by reference in its entirety.

### BACKGROUND

### 1. Technical Field

The present disclosure relates to a method of suppressing a plugging phenomenon occurring during a manufacturing process of an ethylene-acrylic acid copolymer.

### 2. Technical Considerations

In a manufacturing process of an ethylene-acrylic acid copolymer, a plugging phenomenon in which an unreacted acrylic acid comonomer is polymerized into a polyacrylic acid in the rear end of a polymerization reactor, in which a polymerization reaction occurs between an ethylene monomer and an acrylic acid comonomer, and the polyacrylic acid builds up in the reactor and the piping. In particular, since the acrylic acid (AA) comonomer forms an acrylic acid polymer, such as a polyacrylic acid (PAA), due to high reactivity and self-polymerizability, process interruption often occurs which reduces process efficiency.

In order to solve the problem, conventionally, a polymerization reaction of an acrylic acid comonomer was inhibited using a polymerization inhibitor such as hydroquinone (HQ) and phenothiazine (PTZ). However, under anaerobic conditions, polymerization reaction inhibition efficiency is significantly low, and there is a risk of reducing process stability, for example, by introducing a polymerization inhibitor to an ethylene-acrylic acid copolymer as a final product by a circulation process. In addition, the polymerization inhibitor is precipitated in the reactor due to the crystallinity of the polymerization inhibitor described above, so that the polymerization inhibitor rather promotes the plugging phenomenon.

### SUMMARY

A non-limiting embodiment of the present disclosure is directed to providing a method of manufacturing an ethylene-acrylic acid copolymer, which may improve process efficiency by suppressing corrosion and plugging in ethylene-acrylic acid copolymer manufacturing equipment.

In one general and non-limiting aspect, a method of manufacturing an ethylene-acrylic acid copolymer comprises the steps of: (S1) supplying an ethylene monomer and an acrylic acid comonomer to a polymerization reactor to manufacture an ethylene-acrylic acid copolymer; (S2) supplying an acrylic acid comonomer-containing mixture discharged from a front or rear end of the polymerization reactor and a cleaning solvent to a cleaning unit; and (S3) dissolving an polyacrylic acid derived from the acrylic acid comonomer contained in the mixture in the cleaning solvent, wherein the cleaning solvent comprises a polyhydric alcohol-based solvent.

In an exemplary embodiment, the cleaning solvent may have a boiling point of 100° C. to 400° C.

In an exemplary embodiment, the polyhydric alcohol-based solvent may be a dihydric to tetrahydric alcohol-based solvent.

In an exemplary embodiment, step (S1) may further comprise: second compressing the ethylene monomer and the acrylic acid comonomer which are first compressed through a primary compressor with a hyper compressor; supplying the compressed ethylene monomer and acrylic acid comonomer to the polymerization reactor to perform polymerization; and filtering a part of the ethylene monomer separated from a discharge from the polymerization reactor and supplying the filtered ethylene monomer to a front end of the primary compressor or the hyper compressor.

In an exemplary embodiment, the mixture of step (S2) may comprise a first acrylic acid comonomer-containing mixture leaking from the hyper compressor and a second acrylic acid comonomer-containing mixture discharged from the polymerization reactor.

In an exemplary embodiment, the first mixture may be transferred to the cleaning unit through a first supply line which connects the hyper compressor and the cleaning unit, and the second mixture may be transferred to the cleaning unit through a second supply line which connects the polymerization reactor and the cleaning unit.

In an exemplary embodiment, after steps (S3), (S4), the method further comprises discharging a cleaning solution in which the polyacrylic acid is dissolved.

In an exemplary embodiment, in step (S2), a mass ratio of the acrylic acid comonomer:the cleaning solvent supplied to the cleaning unit may be 1:0.1 to 1.

In an exemplary embodiment, steps (S1) to (S4) may be performed in a continuous process.

In an exemplary embodiment, the first supply line and the second supply line may comprise a heat exchanger.

In an exemplary embodiment, the cleaning solvent may pass through the heat exchanger comprised in the first supply line and the second supply line and be supplied to the cleaning unit.

In an exemplary embodiment, a temperature of the cleaning unit may be 0° C. to 50° C.

Other features and aspects will be apparent from the following detailed description, the drawings, and the claims.

### BRIEF DESCRIPTION OF THE DRAWINGS

FIG. 1 is a schematic view of a non-limiting embodiment of a manufacturing process of an ethylene-acrylic acid copolymer according to the principles of the present disclosure;

FIG. 2 is a schematic view of a non-limiting embodiment of a manufacturing process of an ethylene-acrylic acid copolymer according to the principles of the present disclosure; and

FIGS. 3 to 8 are photographs which observed a plugging suppression effect of a cleaning solvent, during polyacrylic acid cleaning by methods according to Examples 1 to 6.

### DETAILED DESCRIPTION

A method of suppressing plugging in a manufacturing process of an ethylene-acrylic acid copolymer of the present disclosure will be described in detail. The terms used in the present specification are selected to be as common as possible and are currently widely used while considering the function of the present disclosure, but they may vary depending on the intention of a person skilled in the art, a convention, the emergence of new technology, or the like. The technical and scientific terms used may have, unless otherwise defined, the meaning commonly understood by those of ordinary skill in the art.

The terms such as “comprise” or “have” or “include” or “contain” in the present specification and the appended claims mean that there is a characteristic or a constitutional element described in the specification, and as long as it is not particularly limited, a possibility of adding one or more other characteristics or constitutional elements is not excluded in advance.

A singular expression in the present specification and the appended claims includes a plural expression, unless otherwise explicitly specified as singular. In addition, a plural expression includes a singular expression, unless otherwise explicitly specified as plural. As used herein, the singular form of “a”, “an”, and “the” include plural referents unless the context clearly states otherwise.

In addition, the numerical range used in the present specification includes all values within the range including the lower limit and the upper limit, increments logically derived in a form and span of a defined range, all double limited values, and all possible combinations of the upper limit and the lower limit in the numerical range defined in different forms. Unless otherwise defined in the specification of the present invention, values which may be outside a numerical range due to experimental error or rounding off of a value are also included in the defined numerical range.

The term of degree “about” and the like used in the present specification and the attached claims are used in the sense of covering an allowable error when the allowable error exists.

In the manufacturing process of an ethylene-acrylic acid copolymer, a plugging phenomenon in which an unreacted acrylic acid comonomer is polymerized into a polyacrylic acid in the rear end of a polymerization reactor, in which a polymerization reaction occurs between an ethylene monomer and an acrylic acid comonomer, and the acrylic acid polymer builds up in the reactor and the piping. In particular, since an acrylic acid (AA) comonomer forms an acrylic acid polymer, such as a polyacrylic acid (PAA), due to high reactivity and self-polymerizability, process interruption often occurs which reduces process efficiency.

In order to solve the problem, conventionally, a polymerization reaction of an acrylic acid comonomer was inhibited using a polymerization inhibitor such as hydroquinone (HQ) and phenothiazine (PTZ). However, the polymerization inhibitor is precipitated in the reactor due to the crystallinity of the polymerization inhibitor described above, such that the polymerization inhibitor contributes to the plugging phenomenon.

Thus, after in-depth research, the present applicant used a cleaning solvent comprising a polyhydric alcohol-based solvent to remove an polyacrylic acid at high speeds even when an acrylic acid comonomer is polymerized, thereby developing a method of manufacturing an ethylene-acrylic acid copolymer, which has improved process efficiency by suppressing the plugging of the reactor and piping and has excellent economic feasibility and productivity.

Hereinafter, the present disclosure will be described with reference to the attached drawings.

The method of manufacturing an ethylene-acrylic acid copolymer according to the present disclosure comprises the steps of: (S1) supplying an ethylene monomer and an acrylic acid comonomer to a polymerization reactor to manufacture an ethylene-acrylic acid copolymer; (S2) supplying an acrylic acid comonomer-containing mixture discharged from a front or rear end of the polymerization reactor and a cleaning solvent to a cleaning unit; and (S3) a cleaning step of dissolving an polyacrylic acid derived from the unreacted acrylic acid comonomer contained in the mixture in the cleaning solvent, wherein the cleaning solvent comprises a polyhydric alcohol-based solvent.

When the ethylene-acrylic acid copolymer is manufactured by the method according to the present disclosure, an polyacrylic acid formed by polymerizing an acrylic acid comonomer is removed rapidly and simply by a cleaning solvent, thereby effectively suppressing a plugging phenomenon occurring in a front or rear end of the polymerization reactor. In addition, since the process proceeds continuously without stopping from a polymerization process to a cleaning process of the ethylene monomer and the acrylic acid comonomer, process efficiency may be improved.

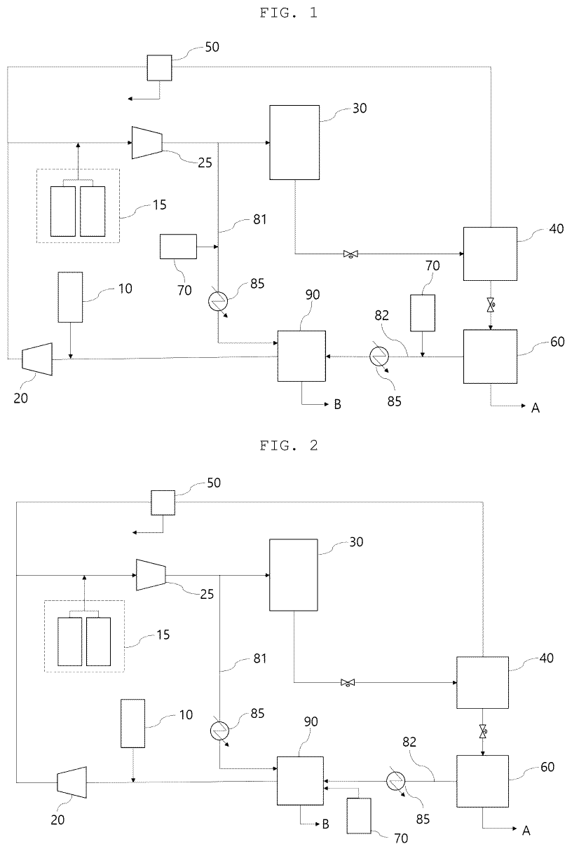

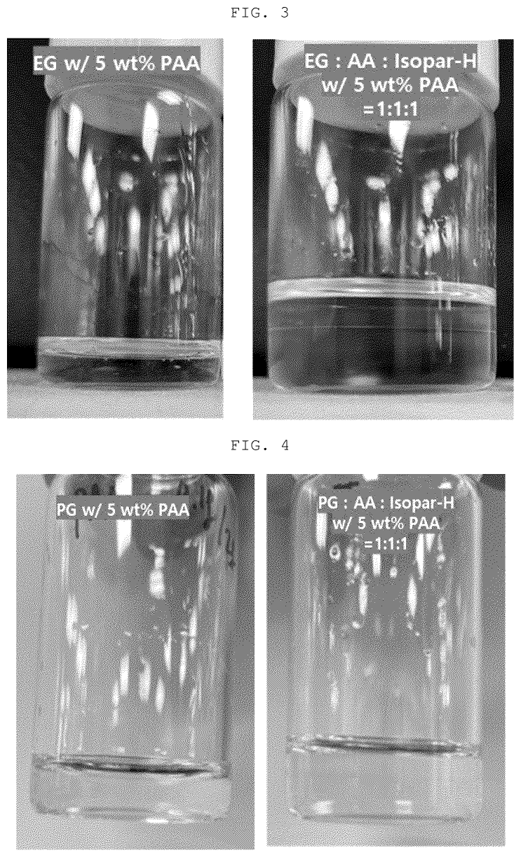

FIGS. 1 and 2 are schematic diagrams showing a manufacturing device of an ethylene-acrylic acid copolymer according to an exemplary embodiment. Referring to FIGS. 1 and 2, in step (S1), the ethylene monomer may be supplied to an ethylene supply unit 10 and first compressed through a primary compressor 20. The ethylene monomer which is first compressed, and the acrylic acid comonomer and the solvent which are supplied from the acrylic acid comonomer and solvent supply unit 15 are supplied to a hyper compressor 25 and second compressed, and then a compressed material comprising the compressed ethylene monomer, the acrylic acid comonomer, and the solvent may be supplied to a polymerization reactor 30. Herein, an acrylic acid comonomer-containing first mixture leaking during compression in the hyper compressor 25 is transferred to a cleaning unit 90, thereby significantly reducing a risk of plugging occurring in the front end of the polymerization reactor.

The ethylene-acrylic acid copolymer, which is the final product (A), is manufactured by a polymerization reaction in the polymerization reactor 30, and a second mixture containing the ethylene-acrylic acid copolymer may be discharged from the polymerization reactor 30. The second mixture discharged from the polymerization reactor 30 passes through a high pressure separator 40 and a low pressure separator 60 to separate the ethylene-acrylic acid copolymer from the second mixture, thereby obtaining the final product (A).

The second mixture from which the ethylene-acrylic acid copolymer has been separated may be supplied to a cleaning unit 90. The second mixture may contain an unreacted ethylene monomer, an polyacrylic acid, a solvent, other additives, an initiator, and the like.

In an exemplary embodiment, the solvent may be any medium in which a copolymerization reaction of an ethylene monomer and an acrylic acid comonomer may occur, and may be, for example, a low-boiling point polar solvent. For example, the solvent may comprise any one or two or more selected from the group consisting of methyl alcohol, ethyl alcohol, isopropyl alcohol, methyl ethyl ketone, tetrahydrofuran, acetone, ethyl acetate, propyl acetate, butyl acetate, 2-methoxyethanol, and 2-ethoxyethanol, but the present disclosure is not interpreted as being limited thereto.

In an exemplary embodiment, in step (S1), a mixing ratio of the ethylene monomer, the acrylic acid comonomer, and the solvent may be 1 to 20 parts by weight of the acrylic acid comonomer and 1 to 20 parts by weight of the solvent, or 3 to 10 parts by weight of the acrylic acid comonomer and 3 to 10 parts by weight of the solvent, with respect to 100 parts by weight of the ethylene monomer, but the present disclosure is not interpreted as being limited thereto.

In step (S1), since the polymerization may be polymerization by an initiator, for example, free radical polymerization, the compressed material supplied to the polymerization reactor 30 may further comprise an initiator, such as a radical initiator, and each monomer reacts under the radical initiator, thereby performing polymerization. As an example, the polymerization may be performed by an initiator mixed solution comprising a radical initiator and a diluting solvent.

A content of the initiator used may be an amount to initiate a radical polymerization reaction, and for example, may be 0.001 parts to 1 parts by weight based on 100 parts by weight of a total monomer. In addition, a content of the diluting solvent used may be properly adjusted, and for example, 5 parts to 1,000 parts by weight of the diluting solvent may be used with respect to 1 part by weight of the initiator. However, it is only described as a specific example, and the present disclosure is not interpreted as being limited thereto.

As an example, the type of radical initiator may be any one to allow radical polymerization between an ethylene monomer and an acrylic acid comonomer to be performed, and a peroxy-based organic peroxide comprising any one or two or more selected peroxycarbonate, peroxydicarbonate, peroxyester, and peroxyketal may be exemplified. However, it is only described as a specific example, and the present disclosure is not interpreted as being limited thereto.

The diluting solvent may be any initiator diluting solvent known in the art, and for example, when a paraffin-based solvent including Isopar-H is used as the diluting solvent, a uniform copolymer may be manufactured and quality decline, such as decreased molecular weight, may be prevented.

In an example of the present disclosure, the compressed material supplied to the polymerization reactor 30 may further comprise a chain transfer agent. As a non-limiting example, the chain transfer agent may be aliphatic and olefin-based hydrocarbons, for example, saturated hydrocarbons having 6 or more carbon atoms, for example, compounds such as hexane, cyclohexane, and octane; ketone-based compounds such as acetone, diethylketone, and diamylketone; aldehyde-based compounds such as formaldehyde and acetaldehyde; and alcohol-based compounds such as methanol, ethanol, propanol, and butanol; and the like. When the chain transfer agent is used, a content of the chain transfer agent used may not be largely limited, and for example, may be 0.1 parts to 20 parts by weight with respect to 100 parts by weight of the total monomer, but the present disclosure is not interpreted as being limited thereto.

As described above, step (S1) may be performed under high temperature and high pressure conditions through pressure and temperature control. As an example, a polymerization temperature and a polymerization pressure may be performed under a temperature condition of 100° C. to 400° C., 150° C. to 350° C., or 200° C. to 300° C., and a pressure condition of 1000 bar to 5000 bar, 1100 bar to 4000 bar, or 1200 bar to 3000 bar, but the present disclosure is not limited thereto.

The polymerization reactor 30 may be any conventionally known polymerization reactor, and for example, may be various reactors, for example, a batch reactor such as autoclave, a continuous stirred tank reactor (CSTR), a tubular reactor, and the like.

In addition, in an example, the primary compressor 20, the hyper compressor 25, the high pressure separator (HPS) 40, and the low pressure separator (LPS) 60 may be any conventionally known ethylene-based polymer manufacturing devices.

As a non-limiting example, in the high pressure separator 40, a part of the second mixture may move to a filter unit 50, pass through a filtering process, and be supplied to a front end of the primary compressor 20 or the hyper compressor 25. A part of the second mixture may contain an unreacted ethylene monomer. The unreacted ethylene monomer recovered to the polymerization reactor 30 and reused in the polymerization reaction, thereby manufacturing the ethylene-acrylic acid copolymer with high efficiency.

Step (S2) is supplying an acrylic acid comonomer-containing mixture including a first mixture discharged from the hyper compressor 25 in the front end of the polymerization reactor 30 and a second mixture discharged from the rear end of the polymerization reactor 30 to a cleaning unit 90. The first mixture may be supplied through a first supply line 81 which connects the hyper compressor 25 and the cleaning unit 90, and the second mixture may be supplied to the cleaning unit 90 which passes through the high pressure separator 40 and the low pressure separator 60 through a second supply line 82 which connects the polymerization reactor 30 and the cleaning unit 90.

In an exemplary embodiment, the first supply line 81 and the second supply line 82 may comprise a heat exchanger 85. A temperature (T₁) of the mixture containing the unreacted acrylic acid comonomer before passing through the heat exchanger 85 and a temperature (T₂) of the mixture containing an unreacted acrylic acid comonomer which has passed through the heat exchanger 85 may satisfy the following Equation 1:

$$3 < {T}_{2} / {T}_{1} < 20 \qquad [ Equation 1 ]$$

wherein T₂/T₁ may be 3 to 20, 6 to 19, or 10 to 18. Within the temperature range, since the mixture containing an unreacted acrylic acid comonomer in a gaseous state is cooled and condensed through the heat exchanger 85, and supplied to the cleaning unit 90, cleaning efficiency is excellent, and a cleaning solution (B) comprising an polyacrylic acid which is dissolved by the cleaning solvent in step (S3) described later may be easily removed.

In step (S2), the cleaning solvent may be supplied to the first mixture and the second mixture simultaneously, or after the mixtures are supplied, the cleaning solvent may be sequentially supplied. In addition, as shown in FIG. 2, the cleaning solvent may be directly supplied to the cleaning unit 90 by a cleaning solvent feeder 70, and more advantageously, as shown in FIG. 1, the cleaning solvent feeder 70 is placed in the first supply line 81 and the second supply line 82, and as the cleaning solvent passes through the heat exchanger 85 and is supplied to the cleaning unit 90, the polyacrylic acid accumulated in the heat exchanger 85 and even the piping of the first supply line 81 and the second supply line 82 may be dissolved to prevent piping blockage.

In an exemplary embodiment, in step (S2), a mass ratio of the acrylic acid comonomer:the cleaning solvent supplied to the cleaning unit 90 may be 1:0.1 to 1, 1:0.3 to 1, or 1:0.5 to 1. In the mass ratio, the cleaning solvent may effectively dissolve the polyacrylic acid derived from the acrylic acid comonomer. When the mass ratio is outside of the ranges, the dissolution effect of the polyacrylic acid may be decreased. When the content of the cleaning solvent is lower than the ranges, the dissolution efficiency of the polyacrylic acid is lowered, and when the cleaning solvent is supplied above the ranges, the dissolution effect of the polyacrylic acid is decreased and also the amount of the cleaning solvent used is excessively increased which decreases economic feasibility.

In addition, in an example, a pressure of the cleaning unit 90 may be 1 bar to 20 bar, 5 bar to 15 bar, or 7 bar to 12 bar, but the present disclosure is not limited thereto.

The mixture containing the acrylic acid comonomer and the cleaning solvent are supplied to the cleaning unit 90, the cleaning solvent may dissolve the acrylic acid comonomer and the polyacrylic acid. In the conventional manufacturing process of the ethylene-acrylic acid copolymer, the unreacted acrylic acid comonomer may be rapidly polymerized high with reactivity and self-polymerization to form a large amount of the polyacrylic acid. The polyacrylic acid accumulates in piping, the reactor, and the like to contaminate process equipment and cause a decrease in process efficiency.

Thus, when the cleaning solvent of the present disclosure is used, though the acrylic acid comonomer is polymerized and the produced polyacrylic acid is attached to piping and the reactor, the acrylic acid comonomer and the polyacrylic acid are rapidly dissolved in the cleaning solvent and removed, thereby effectively suppressing a plugging phenomenon.

In an exemplary embodiment, the boiling point of the cleaning solvent may be 100° C. to 400° C., 100° C. to 350° C., or 150° C. to 300° C. Using the cleaning solvent having the boiling point in the ranges, an excellent cleaning effect may be provided without affecting other processes including the polymerization reaction. When the cleaning solvent having the boiling point below the ranges is used, the cleaning solvent vaporizes inside the cleaning unit 90 to decrease the cleaning effect, and also the cleaning solvent in a gaseous state is introduced into processes other than step (S2) and may adversely affect the manufacturing process of the ethylene-acrylic acid copolymer.

In an example, the cleaning solvent may have a density of 0.5 g/cm³ to 2 g/cm³, 0.6 g/cm³ to 1.8 g/cm³, or 0.8 g/cm³ to 1.5 g/cm³. In the density ranges, the polyacrylic acid may be dissolved at a rapid rate, and when it has a higher density than the ranges, flowability may be decreased to delay a time for the polyacrylic acid to dissolve.

In an exemplary embodiment, the cleaning solvent may comprise a polyhydric alcohol-based solvent. The polyhydric alcohol-based solvent may be an alcohol-based solvent comprising dihydric to tetrahydric, or dihydric and trihydric alcohol groups.

The cleaning solvent may comprise one or more dihydric alcohols selected from the group consisting of ethylene glycol (EG), propylene glycol (PG), and diethylene glycol (DEG), or a trihydric alcohol such as glycerol.

In a non-limiting example, a temperature of the cleaning unit 90 may be 0° C. to 50° C., 5° C. to 45° C., or 10° C. to 40° C., and a pressure of the cleaning unit 90 may be 1 bar to 20 bar, 3 bar to 17 bar, or 5 bar to 15 bar.

In an exemplary embodiment, after steps (S3), (S4) a step of discharging the cleaning solution (B), in which the unreacted acrylic acid comonomer and the polyacrylic acid are dissolved, may be further included to suppress plugging. The process is performed continuously without stopping the process from (S1) manufacturing the ethylene-acrylic acid copolymer to (S4) cleaning the polyacrylic acid and discharging the cleaning solution, thereby providing a method of manufacturing an ethylene-acrylic acid copolymer which has improved process efficiency and excellent economic feasibility and productivity.

In an exemplary embodiment, the cleaning unit 90 may be a vapor-liquid separator. Using the vapor-liquid separator as the cleaning unit 90, in step (S4), the cleaning solution (B) in a liquid state in which the acrylic acid comonomer and the polyacrylic acid are dissolved is discharged to the outside, and simultaneously, a gaseous unreacted residue is resupplied to the front end of the polymerization reactor 30 or the front end of the primary compressor 20, thereby further improving the efficiency of the manufacturing process of the ethylene-acrylic acid copolymer.

Hereinafter, the present disclosure will be described in more detail by the examples.

### Example 1

A polyacrylic acid-containing mixture discharged during a manufacturing process of an ethylene-acrylic acid copolymer and ethylene glycol (EG) as the cleaning solvent, to which 5 weight percent (wt. %) of an polyacrylic acid was added, were supplied to a cleaning unit, and then an polyacrylic acid was cleaned under room temperature and normal pressure conditions. A mass ratio of the acrylic acid comonomer, an initiator diluting solvent (Exxon Mobil, Isopar-H), and the cleaning solvent, which were supplied to the cleaning unit, was 1:1:1.

### Example 2

An polyacrylic acid was cleaned in the same manner as in Example 1, except that propylene glycol (PG) was used instead of ethylene glycol (EG) as the cleaning solvent.

### Example 3

An polyacrylic acid was cleaned in the same manner as in Example 1, except that diethylene glycol (DEG) was used instead of ethylene glycol (EG) as the cleaning solvent.

### Example 4

An polyacrylic acid was cleaned in the same manner as in Example 1, except that glycerol was used instead of ethylene glycol (EG) as the cleaning solvent.

### Example 5

A polyacrylic acid-containing mixture discharged during a manufacturing process of an ethylene-acrylic acid copolymer and ethylene glycol (EG) as the cleaning solvent were supplied to a cleaning unit, and then an polyacrylic acid was cleaned under room temperature and normal pressure conditions. A mass ratio of the acrylic acid comonomer, an initiator diluting solvent (Exxon Mobil, Isopar-H), and a cleaning solvent which were supplied to the cleaning unit was 2:1:1.

### Example 6

An polyacrylic acid was cleaned in the same manner as in Example 5, except that propylene glycol (PG) was used instead of ethylene glycol (EG) as the cleaning solvent.

### Example 7

An polyacrylic acid was cleaned in the same manner as in Example 1, except that a mass ratio of the acrylic acid, the initiator diluting solvent (Exxon Mobil, Isopar-H), and the cleaning solvent which were supplied to the cleaning unit was 1:1:0.1.

### Comparative Example 1

An polyacrylic acid was cleaned in the same manner as in Example 1, except that ethanol was used instead of ethylene glycol (EG) as the cleaning solvent.

### Comparative Example 2

An polyacrylic acid was cleaned in the same manner as in Example 1, except that methanol was used instead of ethylene glycol (EG) as the cleaning solvent.

### Comparative Example 3

An polyacrylic acid was cleaned in the same manner as in Example 1, except that methyl ethyl ketone (MEK) was used instead of ethylene glycol (EG) as the cleaning solvent.

### Comparative Example 4

An polyacrylic acid was cleaned in the same manner as in Example 1, except that the cleaning solvent was not added.

### Comparative Example 5

An polyacrylic acid was cleaned in the same manner as in Example 1, except that a mass ratio of the acrylic acid, the initiator diluting solvent (Exxon Mobil, Isopar-H), and the cleaning solvent which were supplied to the cleaning unit was 1:1:1.5.

When the polyacrylic acid was cleaned by the methods according to Examples 1 to 7 and Comparative Examples 1 to 5, it was evaluated whether the polyacrylic acid was dissolved. In the following Table 1, during the cleaning of the polyacrylic acid, when no color change of the cleaning solution and polyacrylic acid precipitates were not observed with the naked eye, it was indicated as ⊚, when the polyacrylic acid precipitate was not observed with the naked eye, but when the cleaning solution becomes opaque, it was indicated as o, and when the polyacrylic acid precipitates were observed, it was indicated as X.

TABLE 1

| | | | Whether |
|---|---|---|---|
| | | Mass ratio of cleaning | polyacrylic |
| | | solvent:acrylic acid | acid was |
| | Cleaning solvent | comonomer:Isopar-H | dissolved |
| Example 1 | Ethylene glycol | 1:1:1 | ⊚ |
| Example 2 | Propylene glycol | 1:1:1 | ⊚ |
| Example 3 | Diethylene glycol | 1:1:1 | ⊚ |
| Example 4 | Glycerol | 1:1:1 | ⊚ |
| Example 5 | Ethylene glycol | 1:2:0 | ⊚ |
| Example 6 | Propylene glycol | 1:2:0 | ⊚ |
| Example 7 | Ethylene glycol | 1:1:1 | ⊚ |
| Comparative | Ethanol | 1:1:1 | ⊚ |
| Example 1 | | | |
| Comparative | Methanol | 1:1:1 | ⊚ |
| Example 2 | | | |
| Comparative | Methyl ethyl ketone | 1:1:1 | X |
| Example 3 | | | |
| Comparative | None | 0:1:1 | X |
| Example 4 | | | |
| Comparative | Ethylene glycol | 1.5:1:1 | ◯ |
| Example 5 | | | |

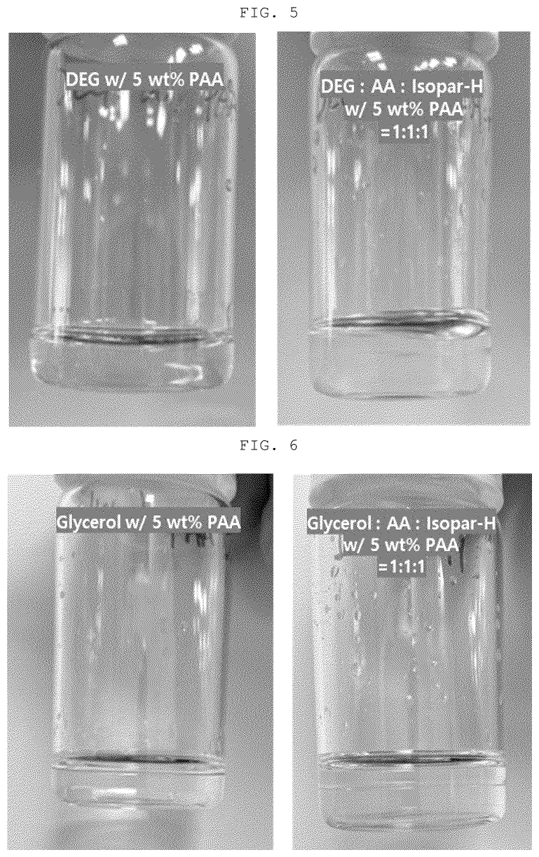

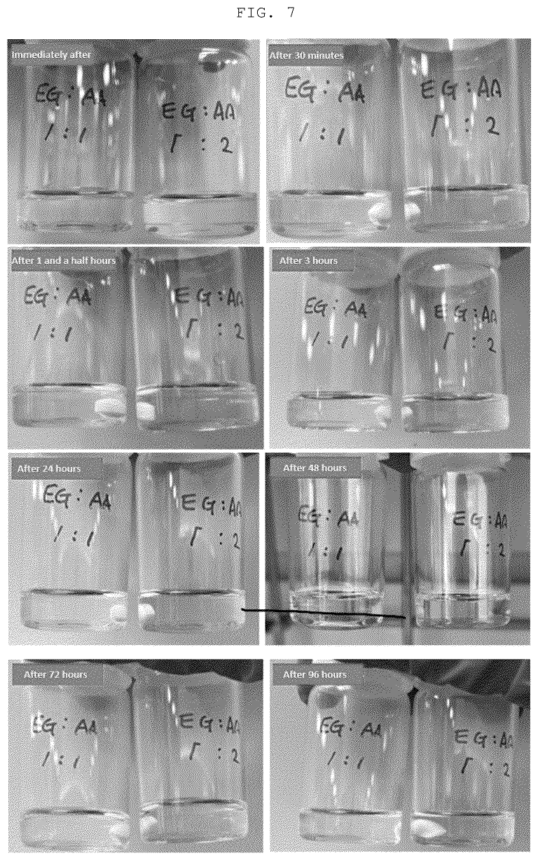

As shown in FIGS. 3 to 8 and Table 1, it was confirmed in Examples 1 to 7 that the acrylic acid comonomer and the polyacrylic acid polymer were rapidly dissolved in the cleaning solvent.

Specifically, FIGS. 3 to 6 are photographs in which when the polyacrylic acid was cleaned by the methods of Examples 1 to 4, respectively, the cleaning solutions in which the acrylic acid comonomer, Isopar-H, and the cleaning solvent were mixed were observed, and show an evaluation of the dissolution effect of the cleaning solvent for the polyacrylic acid.

As shown in FIGS. 3 to 6, in Examples 1 to 4 in which ethylene glycol, propylene glycol, diethylene glycol, and glycerol were used as the cleaning solvent, respectively, though Isopar-H as a diluting solvent was present, considering that phase separation or precipitates of the polyacrylic acid was not produced in the cleaning solution, it was confirmed that the cleaning solvent was able to effectively suppress plugging in the process reactor and piping regardless of whether the diluting solvent was present.

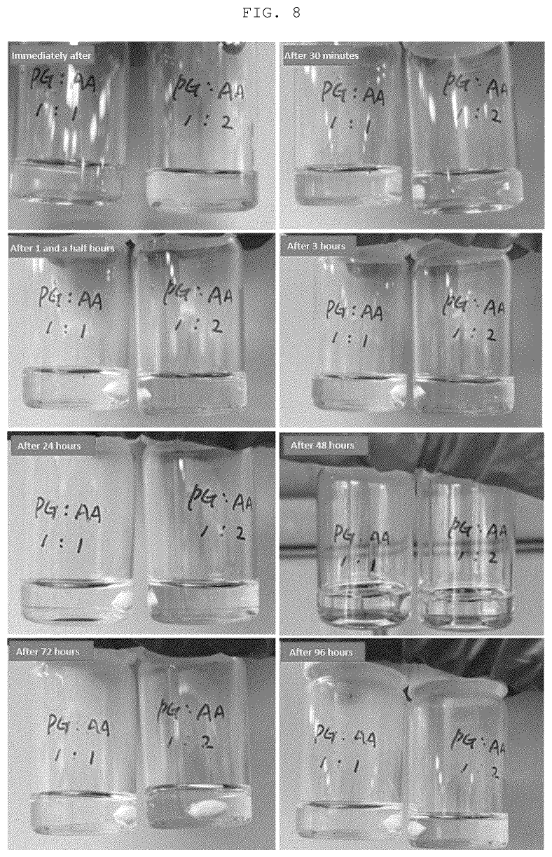

FIG. 7 is a photograph in which ethylene glycol as the cleaning solvent and the acrylic acid comonomer were mixed by the method of Example 5, and then it was observed for 96 hours whether the polyacrylic acid was dissolved, and FIG. 8 is a photograph in which propylene glycol as the cleaning solvent and the acrylic acid comonomer were mixed by the method of Example 6, and then it was observed for 96 hours whether the polyacrylic acid was dissolved.

In Examples 5 and 6, a cleaning effect when a cleaning solvent, to which additional polyacrylic acid was not added, and an acrylic acid comonomer and Isopar-H-containing mixture discharged from the polymerization reactor were mixed was confirmed, and as shown in FIGS. 7 and 8, the acrylic acid comonomer dissolved in the cleaning solution was converted into a polyacrylic acid or the polyacrylic acid was not precipitated even after 96 hours, and thus, long-term stability was confirmed to be excellent.

In Example 7, since the mass ratio of the acrylic acid comonomer and the cleaning solvent was 1:0.1, the content of the cleaning solvent was significantly decreased as compared with Example 1, but the dissolution effect of the polyacrylic acid was excellent. Thus, the amount of the cleaning solvent used was saved, which is favorable from an economic perspective.

Thus, since the polyacrylic acid produced during the manufacturing process of ethylene-acrylic acid was rapidly removed, process efficiency was improved.

However, in Comparative Examples 1 to 3 in which monohydric alcohol and a ketone-based solvent having a low boiling point of 80° C. or lower were used as the cleaning solvent, as shown in Table 1, the ketone-based solvent of Comparative Example 3 did not dissolve the polyacrylic acid. In Comparative Examples 1 and 2 in which monohydric alcohol was used as the cleaning solvent, a solubility of the polyacrylic acid was high, but since the volatility of the cleaning solvent was high, the cleaning solvent vaporized during manufacture of the ethylene-acrylic acid copolymer is introduced to a circulation process and other processes were adversely affected. Therefore, it was confirmed to be inappropriate for use to suppress plugging in the manufacturing process of the ethylene-acrylic acid copolymer.

In Comparative Example 4, in which the cleaning solvent was not included, the polyacrylic acid was formed and precipitated. In Comparative Example 5, in which the mass ratio of the acrylic acid and the cleaning solvent was 1:1.5, polyacrylic acid precipitates which were visible to the naked eye were not observed, but the transparency of the cleaning solution decreased over time and the solution became somewhat opaque. Therefore, as the content of the cleaning solvent as compared with the acrylic acid comonomer was higher, the cleaning effect was decreased and the amount of the cleaning solvent used was increased, which was not good from an economic perspective.

Therefore, when the ethylene-acrylic acid copolymer was manufactured by the method of the present disclosure, the polyacrylic acid derived from the unreacted acrylic acid comonomer was rapidly dissolved in the cleaning solvent, thereby suppressing plugging by the polyacrylic acid. At the same time, since the cleaning solvent of the present disclosure did not adversely affect other processes including the polymerization step of the ethylene monomer and the acrylic acid comonomer, the productivity of the ethylene-acrylic acid copolymer was also maintained to be high. Thus, since the efficiency of the manufacturing process of the ethylene-acrylic acid copolymer was improved, and failure and corrosion of process equipment such as a reactor and piping, caused by plugging was able to be prevented, costs of maintaining process equipment was able to be reduced, and thus, the method of the present disclosure was favorable.

The method of manufacturing an ethylene-acrylic acid copolymer according to the present disclosure may prevent corrosion of a reactor and piping.

In addition, since the process may not be stopped by plugging, a method of manufacturing an ethylene-acrylic acid copolymer, of which the process efficiency is improved and economic feasibility and productivity are excellent, may be provided.

Hereinabove, although the present disclosure has been described by specific matters, limited implementations, and drawings, they have been provided only for assisting the entire understanding of the present disclosure, and the present disclosure is not limited to the implementations, and various modifications and changes may be made by those skilled in the art to which the present disclosure pertains from the description.

Therefore, the spirit of the present disclosure should not be limited to the above-described exemplary embodiments, and the following claims as well as all modifications equal or equivalent to the claims are intended to fall within the scope and spirit of the disclosure.

What is claimed is:

1. A method of manufacturing an ethylene-acrylic acid copolymer, the method comprising the steps of:
(S1) supplying an ethylene monomer and an acrylic acid comonomer to a polymerization reactor to manufacture an ethylene-acrylic acid copolymer;
(S2) supplying an acrylic acid comonomer-containing mixture discharged from a front or rear end of the polymerization reactor and a cleaning solvent to a cleaning unit; and
(S3) dissolving a polyacrylic acid derived from the acrylic acid comonomer contained in the mixture in the cleaning solvent,
wherein the cleaning solvent comprises a polyhydric alcohol-based solvent.

2. The method of manufacturing an ethylene-acrylic acid copolymer of claim 1, wherein the cleaning solvent comprises a boiling point of 100° C. to 400° C.

3. The method of manufacturing an ethylene-acrylic acid copolymer of claim 1, wherein the polyhydric alcohol-based solvent is a dihydric to tetrahydric alcohol-based solvent.

4. The method of manufacturing an ethylene-acrylic acid copolymer of claim 1, wherein step (S1) further comprises:
second compressing the ethylene monomer and the acrylic acid comonomer which were first compressed through a primary compressor with a hyper compressor;
supplying the compressed ethylene monomer and acrylic acid comonomer to the polymerization reactor and performing polymerization; and
filtering a part of the ethylene monomer separated from discharge from the polymerization reactor and supplying the filtered ethylene monomer to a front end of the primary compressor or the hyper compressor.

5. The method of manufacturing an ethylene-acrylic acid copolymer of claim 4, wherein the mixture of step (S2) comprises an acrylic acid comonomer-containing first mixture leaking from the hyper compressor and an acrylic acid comonomer-containing second mixture discharged from the polymerization reactor.

6. The method of manufacturing an ethylene-acrylic acid copolymer of claim 5,
wherein the first mixture is transferred to the cleaning unit through a first supply line which connects the hyper compressor and the cleaning unit, and
wherein the second mixture is transferred to the cleaning unit through a second supply line which connects the polymerization reactor and the cleaning unit.

7. The method of manufacturing an ethylene-acrylic acid copolymer of claim 1, further comprising: after steps (S3), (S4) discharging a cleaning solution in which the polyacrylic acid is dissolved.

8. The method of manufacturing an ethylene-acrylic acid copolymer of claim 1, wherein in step (S2), a mass ratio of the acrylic acid comonomer:the cleaning solvent supplied to the cleaning unit is 1:0.1 to 1.

9. The method of manufacturing an ethylene-acrylic acid copolymer of claim 7, wherein steps (S1) to (S4) are performed in a continuous process.

10. The method of manufacturing an ethylene-acrylic acid copolymer of claim 6, wherein the first supply line and the second supply line comprise a heat exchanger.

11. The method of manufacturing an ethylene-acrylic acid copolymer of claim 10, wherein the cleaning solvent passes through the heat exchanger comprised in the first supply line and the second supply line and is supplied to the cleaning unit.

12. The method of manufacturing an ethylene-acrylic acid copolymer of claim 1, wherein a temperature of the cleaning unit is 0° C. to 50° C.
